(19) United States
(12) Patent Application Publication
(10) Pub. No.: US 2005/0213578 A1
(43) Pub. Date: Sep. 29, 2005

(54) Method and device for managing downlink setup in a packet-switched communications network

(75) Inventors: Francois Duhamel, Montmorency (FR); Didier Lacroix, Chateaufort (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S., Paris (FR)

(21) Appl. No.: 10/529,913

(22) PCT Filed: Sep. 26, 2003
(86) PCT No.: PCT/FR03/02829

§ 371 Date: Jun. 1, 2005

(30) Foreign Application Priority Data
Oct. 3, 2002 (FR) 02/12243

(51) Int. Cl. H04L 12/56

(52) U.S. Cl. 370/395.2

(57) ABSTRACT

A system (D) is dedicated to managing downlink data transfers between a radio access network (BSS) of a packet-switched communications network and mobile stations (MS-k). The system (D) comprises management means (M) adapted, when they receive a request for downlink data transfer to a mobile station (MS-k), to instruct sending of a link set-up request to that mobile station by means of the radio access network (BSS) and then setting up a downlink access, after the reception of a response to that request sent by the mobile station (MS-k).

The invention relates to the field of packet-switched cellular communications networks and in particular to downlink data transfer within such networks.

Cellular networks, for example general packet radio service (GPRS) cellular networks, generally include a radio access network that is also known as the base station system (BSS) and is responsible in particular for managing the allocation of resources, also known as logical channels (such as radio link channels), allowing connections to be set up with mobile stations, such as mobile telephones.

Two types of link can be set up for bidirectional exchange of data between a mobile station and the BSS: a downlink from the BSS to the mobile station and an uplink from the mobile station to the BSS. If a link (also known as an access) is set up at the instigation of the mobile station, the mobile station must submit an uplink access request to the BSS. If the link (access) is set up at the instigation of the BSS, the BSS automatically assigns downlink resources to the mobile station.

The link set-up procedures following uplink or downlink access requests generally do not give rise to any problem under normal conditions of operation. However, if an uplink (respectively downlink) access request is submitted at substantially the same time as a downlink (respectively uplink) access request, the mobile station may receive two different sets of instructions (also known as assignments) from the BSS that designate two links associated with resources that may be incompatible, which would prevent the exchange of data. The BSS sends a first set of instructions with its downlink access request and a second set of instructions after receiving an uplink access request from the mobile station. Because of the transmission delays affecting the sets of instructions at the level of the BSS, the BSS does not have time to register the fact that the second set of instructions is intended for the same mobile station as the first set of instructions. The BSS then has to use complex procedures to resolve the situation and to make available again the resources that have been assigned unnecessarily.

Thus an object of the invention is to solve this problem.

To this end the invention proposes a method of managing downlink data transfers between a radio access network (BSS) of a packet-switched communications network, for example a GPRS network, and mobile stations.

In the present context, the expression “downlink data transfer” means setting up a bidirectional link (downlink and uplink) at the initiative of the radio access network. Consequently, the expression “uplink data transfer” means setting up a bidirectional link (uplink and downlink) at the initiative of a mobile station.

The method of the invention is characterized in that, in the event of a request for downlink data transfer to a mobile station, it consists in sending a link set-up request, such as a paging request, to said mobile station by means of the radio access network (BSS) and, on reception by said radio access network of a response to said request, such as a paging response, sent by the mobile station, setting up a downlink access (link) by means of the radio access network, for example by means of a downlink assignment, to enable data to be sent to said mobile station.

The BSS therefore obliges the mobile station to identify itself and there can no longer be any conflict of downlink resources at the level of the mobile station.

According to another feature of the invention, the link set-up request includes commands that request said mobile station to send said radio access network an uplink access (link) request and, on receipt of said request, network resources for setting up said uplink access (link) are assigned, for example by means of an uplink assignment, so that said mobile station can send said response to the link set-up request over that uplink access.

The uplink access request generated by a mobile station preferably enables the radio access network to locate the mobile station. Once it is in possession of the elements characterizing the position of the mobile station (such as the identifier of the cell and the timing advance value) and a reference identifier such as a random reference supplied by the mobile station in its uplink access request, the radio access network has the information it needs to set up the uplink access.

It is also advantageous for the response (which is a paging response, for example) to include a call identifier specific to the mobile station and known to the communications network, such as the TLLI of the mobile station. Once it has been extracted, that call identifier enables the radio access network to obtain information necessary for setting up the downlink access (link).

Furthermore, depending on whether the initial status of the mobile station is “ready” or “standby”, the link set-up request is preferably generated by the radio access network or by a serving server of the communications network, such as a SGSN, that is coupled to the radio access network.

The invention also proposes a system for managing downlink data transfers between a radio access network of a packet-switched communications network and mobile stations.

The system is characterized in that it comprises management means adapted, on receiving a request for downlink data transfer to a mobile station, to instruct the sending of a link set-up request to said mobile station by means of said radio access network, followed by the setting up of a downlink access (link) after the reception of a response to that request sent by the mobile station.

When the initial status of the mobile station is “ready”, the management means instruct the radio access network to generate a link set-up request that requests the mobile station to send the radio access network an uplink access (link) request that enables the radio access network to assign network resources for setting up the uplink access (link) that in turn enables the mobile station to send its response to the link set-up request.

The invention further proposes a radio access network equipment equipped with a management system of the type described above, such as a network node (or controller), also known as a base station controller (BSC), or a control unit coupled to one or more nodes (controllers) for managing packet transfer. The equipment is preferably able to deduce the position of a mobile station from the uplink access (link) request generated by that mobile station. Once it is in possession of elements characterizing the position of the mobile station (such as the identifier of the cell and the timing advance value) and a reference identifier (such as a random reference supplied by the mobile station in its uplink access request), the equipment has the information needed to set up the uplink access.

The equipment is preferably also able, if the response (which is a paging response, for example) includes a call identifier of the mobile station, for example its TLL, to extract the call identifier from the response, in order to set up the downlink access (link).

The invention also proposes a radio access network, such as a BSS, including a radio access network equipment of the type defined above.

Other features and advantages of the invention will become apparent on reading the following detailed description and examining the appended drawings, in which:

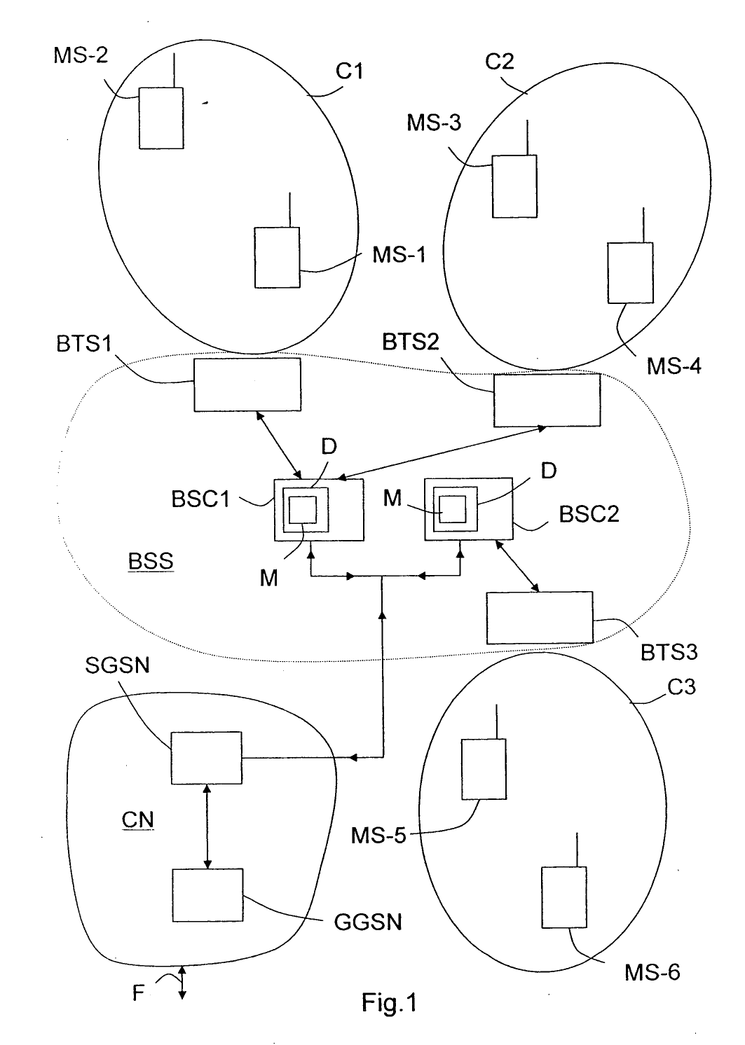

FIG. 1 is a diagram of part of a communications network equipped with management systems of the invention installed in network nodes (controllers), and

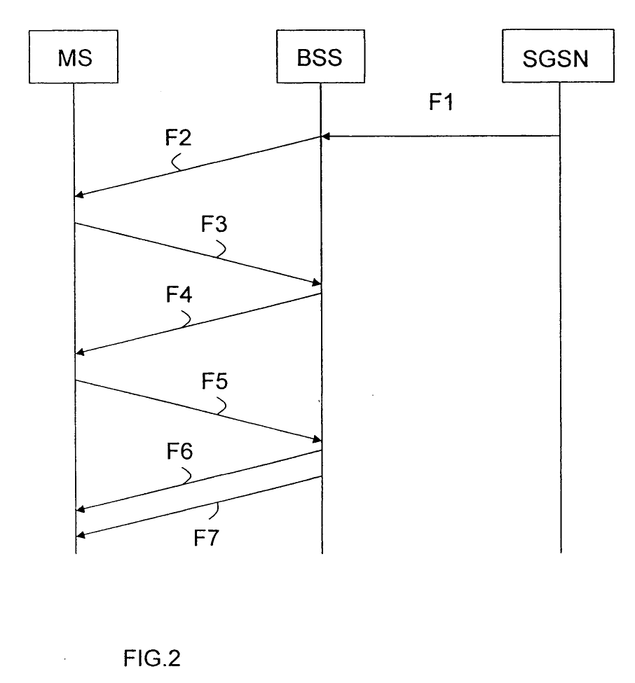

FIG. 2 is a diagram of the main steps of the method of the invention of setting up a downlink at the initiative of a network node (controller).

The appended drawings constitute part of the description of the invention and may, if necessary, contribute to the definition of the invention.

The invention relates to a system and a method for managing downlink data transfers between a packet-switched cellular communications network, for example a GPRS network, and mobile stations such as mobile telephones.

As shown in FIG. 1, and broadly speaking but nevertheless in sufficient detail to enable the invention to be understood, a GPRS cellular network can be regarded as a core network (CN) coupled to one or more other public and/or private networks (the connection to these other networks is indicated in FIG. 1 by the two-way arrow F) and to a radio access network, also known as a base station system (BSS).

The core network CN generally includes a first server called the Service GPRS Serving Node (SGSN) for uplink and downlink data packet transfers between the BSS and the mobile stations MS and a second server called the Gateway GPRS Serving Node (GGSN), which is coupled to the SGSN and provides a logical interface between the GPRS network and the other public and/or private networks.

Moreover, the radio access network or BSS generally includes, firstly, a plurality of radio network nodes (or controllers), also known as base station controllers (BSC), coupled to the core network CN via an interface, and, secondly, a plurality of base transceiver stations (BTS) each associated with one or more cells C, each of which covers a radio area and which are coupled individually or in groups of at least two to one of the BSCs via a logical interface.

In the example shown in FIG. 1, the BSS comprises two base station controllers BSCi (i=1 or 2) and three base transceiver stations BTSj (j=1 to 3). To be more precise, the first BSC (BSC1) is coupled to the base transceiver stations BTS1 and BTS2 and the second BSC (BSC2) is coupled to the base transceiver station BTS3. Moreover, each BTSj controls a cell Cj defining a geographical area (below, this area is regarded as synonymous with the corresponding cell Cj). Of course, the base transceiver stations could control more than one cell and a geographical area could be defined by more than one cell or more than one cell portion. Finally, the mobile stations are mobile telephones MS-k (k=1 to 6) capable of exchanging data with other equipments of the network in accordance with the Wireless Application Protocol (WAP).

Given its function, the management system D of the invention is installed in the radio access network BSS, preferably in each network controller BSCi of the BSS, as shown in FIG. 1. However, it could be installed in a different equipment of the radio access network (BSS), and in particular in a control unit for managing packet transfers coupled to one or more nodes (controllers) in order to manage in parallel downlink data transfers controlled by those network controller(s).

The management system D includes a management module M capable of detecting each downlink data transfer request designating a mobile telephone MS in data received by the BSC in which it is installed. Accordingly, when it detects a request for downlink transfer to a mobile telephone MS-k, it instructs the BSS to send that mobile station a link set-up request, preferably in the form of what is known in the art as a paging request. To be more precise, the system D instructs the sending of a link set-up request to a mobile telephone MS-k when said mobile telephone is in the packet idle mode (PIM) and its GPRS Mobility Management (GMM) status is “ready”.

In the above situation, the management module M instructs the BSCi in which it is installed to generate the request, which is then sent to the mobile telephone MS-k on the common control channel (which may be the channel called the master PDCH) via the BTSj controlling the cell Cj in which said mobile telephone MS-k is situated.

When a downlink data transfer request designates a mobile telephone MS-k that is in the inactive mode and whose GMM status is “standby”, the SGSN of the core network CN automatically generates the link set-up request sent to the mobile telephone MS-k. The request is sent to the BSCi concerned, and thence to the mobile telephone MS-k, on the common control channel (which may be the master PDCH), via the BTSj controlling the cell Cj in which the mobile telephone MS-k is situated.

The BSCs and the SGSN are designed to generate paging requests and there is therefore no need to modify them.

The link set-up request preferably includes commands (instructions) requesting the mobile telephone MS-k to send the radio access network BSS an uplink access (link) request on the dedicated access request channel. This uplink access request includes a reference identifier (for example the identifier known as the random reference) supplied by the mobile telephone MS-k and enabling it, when it is integrated into a downlink message from the BSS, to understand that the message is addressed to it. Moreover, the access request enables the BSCi concerned to determine the position of the mobile telephone MS-k that originated it, and consequently to assign network resources for setting up the uplink access (link) with the mobile telephone MS-k.

Accordingly, when the BSCi concerned receives the uplink access request from the mobile telephone MS-k, it extracts the reference identifier from it and determines the elements that characterize the position of the mobile telephone (such as the identifier of its cell and the timing advance value). It then determines a first set of instructions defining the uplink resources assigned to the requested uplink access and sends the mobile telephone MS-k an uplink assignment message including the first set of instructions and the reference identifier extracted from the uplink access request on the common control channel (which may be the master PDCH).

When the mobile telephone MS-k receives the uplink assignment message, it recognizes the reference identifier that it has previously supplied and understands that the message is addressed to it. It then extracts from the message the information that enables it to configure immediately its sender module on the uplink channel assigned by the BSCi, and consequently to respond to the paging request previously received.

The mobile telephone MS-k therefore generates a response, which is preferably a paging response, including a call identifier known to the radio access network BSS, and in particular to the BSCi. The call identifier is preferably the TLLI that was assigned to the mobile telephone MS-k by the SGSN and is associated with the routing area in which it is situated.

When the BSCi receives the response sent by the mobile telephone MS-k on the uplink channel assigned to it, it extracts therefrom the call identifier (TLLI), enabling it to obtain the information needed to set up the downlink access (link) with the mobile telephone MS-k. The BSCi then determines a second set of instructions defining the downlink resources assigned to the uplink access that will enable it to transfer to the mobile telephone MS-k data received from the network equipment. It then sends the mobile telephone MS-k a downlink assignment message including the second set of instructions, preferably on the assigned uplink channel. The expression “assigned uplink channel” means the channel enabling the mobile station to send data to the BSS and enabling the BSS to send service information or signaling to the mobile station.

On receipt of the downlink assignment message, the mobile telephone MS-k is in possession of the information enabling it to configure immediately its receiver module on the downlink channels assigned by the BSCi, and consequently to receive data awaiting transfer.

A few moments after sending the downlink assignment message (in fact long enough after this to enable the mobile telephone MS-k to configure its receiver module), the BSCi sends data awaiting transfer to the mobile telephone MS-k on one of the assigned downlink access channels. The downlink access (link) and the uplink access (link) have then been set up and the network can exchange data bidirectionally with the mobile telephone MS-k.

The management module M of the system D of the invention can be implemented in the form of software modules, at least in part in the form of electronic circuits (hardware), or in the form of a combination of software modules and electronic circuits.

There are described next with reference to FIG. 2 the main steps of a downlink data transfer method of the invention, for example as implemented by the management system D described above.

A communications network equipment, for example a server (or a fixed or mobile telephone), requires to send data to a (another) mobile telephone MS-k of the GPRS network situated in a cell Cj controlled by a base transceiver station (BTS) managed by one of the BSCs of the BSS access network of the GPRS network. The mobile telephone MS-k that is the destination of “downlink” data is in the inactive mode and its GMM status is “ready”.

The (downlink) data to be transferred to the mobile telephone MS-k reaches the core network CN, to be more precise its GGSN, which forwards the data to the SGSN, which then sends the data to the appropriate BSCi of the BSS (arrow F1). On receiving this data, the management system D detects the downlink data and instructs the BSCi to send the mobile telephone MS-k a link set-up request (paging request). The BSCi executes this instruction (arrow F2).

If the mobile telephone MS-k is in the inactive mode and its GMM status is “standby”, the SGSN automatically generates the link set-up request (paging request) and sends it to the BSCi in order for the BSCi to forward it to the mobile telephone MS-k.

On receiving this link set-up request, the mobile telephone MS-k sends the BSS an uplink access request including its reference identifier (arrow F3). On receiving the uplink access request, the BSCi extracts the reference identifier, defines the uplink resources to be assigned to the requested uplink access (link), and sends the mobile telephone MS-k an uplink assignment message defining said uplink resources and including its reference identifier (arrow F4).

On receiving this uplink assignment message, the mobile telephone MS-k recognizes its reference identifier, configures its sending module on the uplink channel assigned by the BSCi, and sends the BSCi a response (paging response) to the link set-up request previously received, including a call identifier (TLLI) (arrow F5).

On receiving the response, the BSCi extracts the call identifier (TLLI), determines the downlink resources to be assigned to the downlink access (link), and sends the mobile telephone MS-k a downlink assignment message defining said uplink resources (arrow F6).

On receiving this downlink assignment message, the mobile telephone MS-k configures its receiver module on the downlink channels assigned by the BSCi. The downlink access (link) and the uplink access (link) having been set up, the network and the mobile telephone MS-k can exchange data bidirectionally. The BSCi can therefore send the mobile telephone MS-k data awaiting transfer (arrows F7).

The invention prevents the conflict for assignment of downlink resources that could arise in the prior art networks, in particular in the case of downlink access requests crossing uplink access requests. This economizes on the radio resources assigned during the crossover and certain calculation (CPU) resources used by the radio resource allocation algorithm.

Furthermore, the invention significantly simplifies the mobile station search procedure in the event of loss of contact given that, instead of attempting to assign downlink resources, the radio access network asks the mobile station to identify itself.

Moreover, the invention simplifies the implementation of the GPRS protocol in that the number of special cases is significantly reduced.

The invention is not limited to the embodiments of a system, radio access network equipment and method described above by way of example only, but encompasses all variants that the person skilled in the art might envisage that fall within the scope of the following claims.

Thus there has been described an example of a management system installed in a network controller to manage downlink data transfers. However, the management system could be installed in a different equipment of the radio access network, for example a control unit for controlling packet transfers coupled to one or more nodes (controllers) to manage in parallel downlink data transfers controlled by the network node(s) (controller(s)) concerned.

Furthermore, implementations of the system and method of the invention in a GPRS packet-switched cellular communications network have been described. The invention is not limited to this type of network, however. It can equally apply to new types of cellular network in which terminal-equipments are mobile and may lose contact with control equipment, in which case contact is resumed either at the initiative of the terminal-equipment or at the initiative of equipment controlling packet transfer. If the control equipment wishes to resume contact with a terminal-equipment, the system of the invention sends the terminal-equipment, within a restricted perimeter, a message (request) that requests it to resume contact by identifying itself.

The invention can equally apply to packet-switched communications networks in which the terminal-equipment is not able to establish a permanent contact, for example because of restricted power consumption or because it must be in contact with a plurality of control systems and uses only one communication means at a time. In this case, the network takes over from the terminal-equipment, sending it requests to resume contact by identifying itself.

1. A method of managing downlink data transfers between a radio access network (BSS) of a packet-switched communications network and mobile stations (MS-k), characterized in that, in the event of a request for downlink data transfer to a mobile station (MS-k), it consists in sending a link set-up request to said mobile station by means of the radio access network (BSS) and, on reception by said radio access network (BSS) of a response to said request sent by the mobile station (MS-k), setting up a downlink access to send the data to said mobile station (MS-k).

2. A method according to claim 1, characterized in that said link set-up request requires said mobile station (MS-k) to send said radio access network (BSS) an uplink access request and, on receipt of said request, network resources for setting up said uplink access are assigned so that said mobile station (MS-k) can send said response to the link set-up request over that uplink access.

3. A method according to claim 2, characterized in that said uplink access request includes a reference identifier recognizable by said mobile station (MS-k) and, on receipt of the uplink access request, said reference identifier is extracted in order to set up said uplink access.

4. A method according to claim 1, characterized in that said response includes a call identifier of the mobile station, known to said network, and, on receipt of said response, said call identifier is extracted in order to set up said downlink access.

5. A method according to claim 1, characterized in that said link set-up request is generated by said radio access network (BSS).

6. A system (D) for managing downlink data transfers between a radio access network (BSS) of a packet-switched communications network and mobile stations (MS-k), characterized in that it comprises management means (M) adapted, on receiving a request for downlink data transfer to a mobile station (MS-k), to instruct sending of a link set-up request to said mobile station by means of said radio access network (BSS), followed by setting up a downlink access after the reception of a response to that request from said mobile station (MS-k).

7. A system according to claim 6, characterized in that said management means (M) are adapted to instruct said radio access network (BSS) to send a link set-up request that requests said mobile station (MS-k) to send said radio access network (BSS) an uplink access request so that on receipt of said request said radio access network (BSS) is able to assign network resources for setting up said uplink access enabling said mobile station (MS-k) to send said response to the link set-up request.

8. An equipment (BSC) of a radio access network (BSS) of a packet-switched communications network, characterized in that it includes a system (D) according to claim 6.

9. An equipment according to claim 8, characterized in that it is adapted, when said uplink access request includes a reference identifier recognizable by said mobile station (MS-k), to extract said reference identifier from the received uplink access request in order to set up said uplink access.

10. An equipment according to claim 8, characterized in that it is adapted, when said response includes a call identifier of the mobile station (MS-k) known to said communications network, to extract the call identifier from said response in order to set up said downlink access.

11. An equipment according to claim 8, characterized in that it takes the form of a base station controller (BSC).

12. An equipment according to claim 8, characterized in that it takes the form of a packet transfer control unit.

13. A radio access network (BSS) of a packet-switched communications network, characterized in that it includes an equipment (BSC) according to claim 8.
